(19) United States
(12) Patent Application Publication
(10) Pub. No.: US 2015/0321266 A1
(43) Pub. Date: Nov. 12, 2015

(54) DEVICE SYSTEM HAVING A POSITIONING APPARATUS FOR DETERMINING A BORE CENTER POINT

(71) Applicant: HILTI AKTIENGESELLSCHAFT, Schaan (LI)

(72) Inventors: Christian Sattler, Biessenhofen (DE); Gabor Vida, Chur (CH)

(21) Appl. No.: 14/443,926

(22) PCT Filed: Nov. 19, 2013
(86) PCT No.: PCT/EP2013/074137

§ 371 Date: May 19, 2015

(30) Foreign Application Priority Data
Nov. 21, 2012 (DE) 10 2012 221 262.0

(51) Int. Cl. B23B 49/00; B25H 1/00

(52) U.S. Cl. CPC B23B 49/00; B25H 1/0092; B25H 1/0042; B23B 2260/092

(57) ABSTRACT

A device system (10) for drilling a hole (26) having a center point (M) in a substrate (22), said device system including a power tool (12) with a drilling head (14) that can be attached to a drive shaft (15) and that can rotate around an axis of rotation (17), a tool stand (11) with a guide rail (23) and a guide block (24) to hold the power tool (12), a feed mechanism (13) for moving the power tool (12) along the guide rail (23), and a positioning apparatus (27) for determining the center point (M) of the hole (26) that is to be drilled, whereby the positioning apparatus (27) includes an emitter (34) to emit one or more laser beams.

The present invention relates to a device system with a positioning apparatus for determining the center point of a drill hole.

### BACKGROUND

German utility model DE 20 2004 005 221 U1 describes a device system consisting of a tool stand, a power tool arranged movably on the tool stand, and a feed mechanism for moving the power tool along the tool stand. The power tool is configured as a core drill and comprises a drilling head that is attached to a drive shaft and that can rotate around an axis of rotation. The drilling head creates a drill hole in the substrate, said hole having a certain diameter and a center point. The tool stand comprises a guide rail and a guide block to hold the core drill, whereby the core drill is arranged on the guide rail via the guide block and can be moved along the guide rail by means of the feed mechanism.

In order to align the axis of rotation with the center point of the desired drill hole, the device system has a positioning apparatus with an emitter configured as a laser source. The laser source emits one or more laser beams that mark the position of the axis of rotation on the surface of the substrate that is to be worked. The housing of the positioning apparatus is configured to be cylindrical and it has a threaded connection with which the positioning apparatus is screwed onto the drive shaft.

Japanese patent document JP 2000 354904 discloses another known positioning apparatus for determining the center point of a drill hole for a device system, comprising a core drill, a tool stand, and a feed mechanism. The positioning apparatus has a laser source that emits one or more laser beams, and it is attached to the drive shaft by means of a magnet.

### SUMMARY OF THE INVENTION

A drawback of the known positioning apparatuses for determining the center point of a drill hole is that the positioning apparatuses are attached to the drive shaft. The drilling head has to be dismantled from the drive shaft before the center point of the drill hole can be determined by means of the positioning apparatus and the axis of rotation can be aligned with the center point of the drill hole.

It is an object of the present invention to provide a positioning apparatus for quickly and precisely determining the center point of a drill hole in a way that reduces the work for the operator. There should be no need to dismantle the drilling head in order to determine the center point of the drill hole.

The present invention provides that the positioning apparatus can be attached to the guide rail by means of a fastener. Since the positioning apparatus can be attached to the guide rail, the drilling head can be mounted on the drive shaft when the axis of rotation is aligned with the center point of the drill hole. The guide block and the power tool are moved upwards by the operator via the feed mechanism so that there is sufficient space for the positioning apparatus between the bottom of the drilling head and the substrate. The positioning apparatus is placed onto the guide rail and the fastener affixes the positioning apparatus on the guide rail.

Preferably, the fastener has a magnet. The magnet permits a simple assembly and disassembly of the positioning apparatus and it affixes the positioning apparatus onto the guide rail. The positioning apparatus according to the invention permits a quick determination of the center point of a hole that is to be drilled.

Preferably, the positioning apparatus has a guide on a side facing the guide rail. Via this guide, which is adapted to the guide rail, the alignment of the positioning apparatus is defined and it is ensured that the laser marking coincides with the axis of rotation of the drive shaft and of the drilling head. The correct alignment of the positioning apparatus is particularly important for a fastener that is configured as a magnet, and it permits a precise determination of the center point of the hole that is to be drilled.

In a preferred embodiment, the positioning apparatus comprises a laser unit that has the emitter as well as an adapter part that has the fastener, whereby the laser unit and the adapter part can be connected via a connector. The two-part structure of the positioning apparatus consisting of the laser unit and the adapter part makes it possible to use the positioning apparatus on different tool stands and/or different power tools. Since the distance between the drive shaft of a power tool and the guide rail of a tool stand can vary for different power tools and guide rails, the distance has to be taken into account when the positioning apparatus is going to be used on different tool stands or power tools.

Especially preferably, the device system comprises a first adapter part for a first power tool or first tool stand, and a second adapter part for a second power tool or second tool stand, whereby the first and second power tools or the first and second tool stands differ in terms of the distance between the drive shaft and the guide rail. The distances between the drive shaft of a power tool and the guide rail of a tool stand are adapted by means of the adapter parts. A fitting adapter part is provided for each power tool and for each tool stand. The housing part with the emitter is assembled with the fitting adapter part and subsequently attached to the guide rail.

Embodiments of the invention will be described below with reference to the drawing. The drawing does not necessarily depict the embodiments true-to-scale, but rather, the drawing—where necessary for the sake of elucidation—is shown in schematic and/or slightly distorted form. Regarding any additions to the teaching that can be gleaned directly from the drawing, reference is hereby made to the pertinent state of the art. Here, it has to be taken into account that many modifications and changes relating to the shape and to the detail of an embodiment can be made without departing from the general idea of the invention. The features of the invention disclosed in the description, in the drawing as well as in the claims can be essential for the refinement of the invention individually as well as in any desired combination. Moreover, all combinations of at least two of the features disclosed in the description, in the drawing and/or in the claims fall within the scope of the invention. The general idea of the invention is not limited to the exact form or detail of the preferred embodiment shown and described below nor is it limited to a subject matter that would be limited in comparison to the subject matter put forward in the claims. At given rated ranges, values that fall within the specified limits are also to be disclosed as limit values and to be used and claimed as desired. For the sake of clarity, identical or similar parts or else parts with an identical or similar function are designated by the same reference numerals below.

### BRIEF DESCRIPTION OF THE DRAWINGS

The following is shown:

FIG. 1 a device system according to the invention consisting of a core drill and a tool stand onto which a positioning apparatus for determining the center point of a drill hole has been attached;

FIG. 2 the tool stand of FIG. 1 and the positioning apparatus with a laser unit that generates a laser marking, and an adapter part that is attached to the guide rail by means of a magnet; and

FIG. 3 the positioning apparatus of FIG. 2 with the laser unit and several adapter parts for various core drills or tool stands.

### DETAILED DESCRIPTION

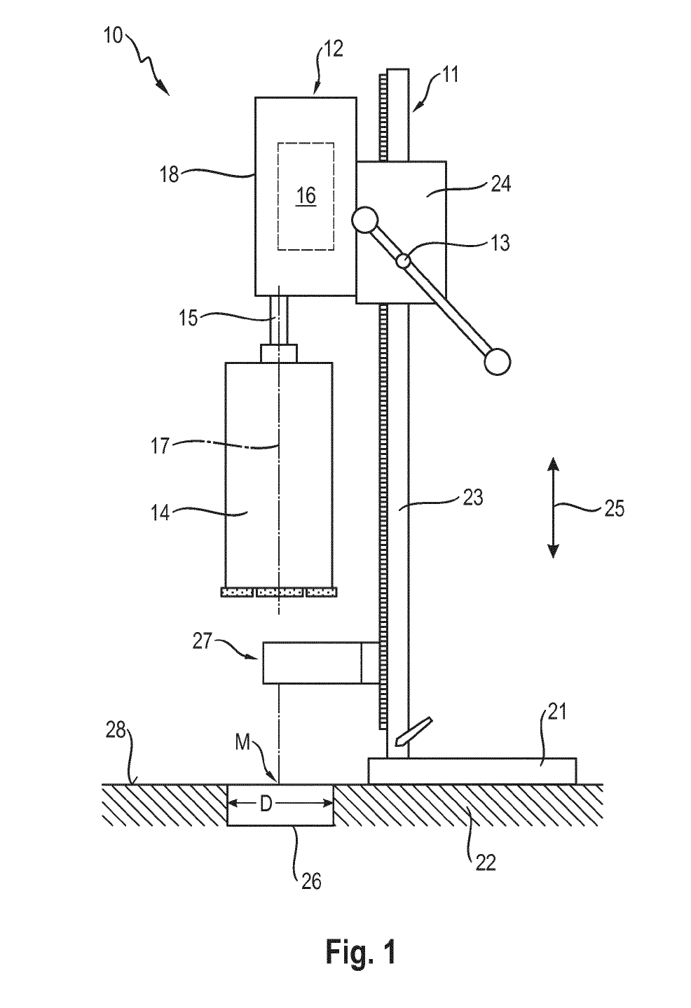

FIG. 1 shows a device system 10 according to the invention, consisting of a tool stand 11, a power tool 12 arranged movably on the tool stand 11, and a feed mechanism 13 for moving the power tool 12 along the tool stand 11.

The power tool is configured as a core drill 12 and comprises a processing tool configured as a drilling head 14 that is arranged on a drive shaft 15 and that is driven by a drive means 16 around an axis of rotation 17. The term “drive means” refers to the combination of all of the drive components for the drilling head 14, except for the drive shaft 15. The drive means 16 shown schematically in FIG. 1 is arranged in a device housing 18.

The tool stand 11 consists of a baseplate 21 that is attached to a substrate 22 that is to be worked, and of a guide rail 23 that is connected to the baseplate 21. The core drill 12 is arranged on the guide rail 23 via a guide block 24, and it can be moved by means of the feed mechanism 13 along the guide rail 23 in a feed direction 25 that is parallel to the axis of rotation 17. The drilling head 14 drills a hole 26 in the substrate, said drill hole 26 having a diameter D and a center point M. Here, the diameter D corresponds to the diameter of the drilling head 14, and the center point M of the drill hole 26 is on the axis of rotation 17 of the drilling head 14.

Before the hole is drilled in the substrate 22, the operator has to position the drilling head 14 in such a way that the axis of rotation 17 of the drilling head 14 coincides with the center point M of the desired drill hole 26. In order to quickly and precisely determine the center point M of the desired drill hole 26, the device system 10 has an apparatus 27 for positioning the drilling head 14. The positioning apparatus 27 is attached to the guide rail 23 and it creates a laser marking on a surface 28 of the substrate 22.

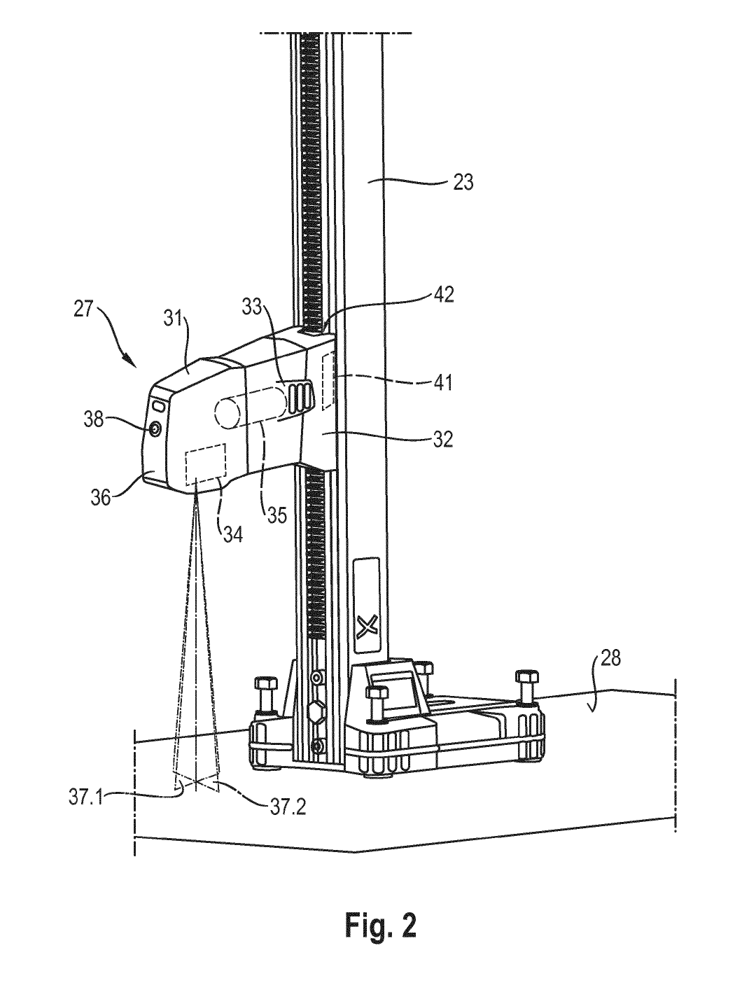

In an enlarged view, FIG. 2 shows the positioning apparatus 27 of FIG. 1 that is attached to the guide rail 23. The positioning apparatus 27 is made up in two parts consisting of a laser unit 31 and an adapter part 32. The laser unit 31 and the adapter part 32 are connected to each other via a connector 33 configured as an adapter latch.

The laser unit 31 comprises a beam unit 34 and a power supply 35, which are arranged in a housing part 36. The beam unit generates two linear laser beams 37.1, 37.2 that run perpendicular to each other and that intersect at an intersection point. The intersection point of the two laser beams 37.1, 37.2 marks the axis of rotation 17 of the drilling head 14. In the housing part 36, there is an ON-OFF switch 38 by means of which the laser unit 31 is switched on. After it has been switched on, the beam unit 34 emits the two linear laser beams 37.1, 37.2. The switched-on laser unit 31 is switched off by pressing the ON-OFF switch 38 once again; moreover, the laser unit 31 switches itself off automatically after a pre-set period of time, for example, after 1 minute.

The adapter part 32 serves to attach the positioning apparatus 27 to the guide rail 23. In the adapter part 32, there is a fastener configured as a magnet 41 that adheres to the guide rail 23. The magnet 41 makes it possible to easily assemble and disassemble the positioning apparatus 27, and it affixes the positioning apparatus 27 to the guide rails 23. The shape, the strength and the number of magnets 41 are adapted to the laser unit 31. Instead of one strong magnet, for example, several weaker magnets can be used as the fastener.

The back of the adapter part 32 facing the guide rail 23 has a guide 42 that is adapted to the guide rail 23. Via the guide 42, the alignment of the positioning apparatus 27 is defined and it is ensured that the intersection point of the two laser beams 37.1, 37.2 coincides with the axis of rotation 17 of the drive shaft 15 and of the drilling head 14. The adapter part 32 can also be moved upwards or downwards along the guide rail 23 via the guide 42.

In order to use the positioning apparatus 27 to determine the center point M of the drill hole 26, the core drill 12 is moved upwards until, between the surface 28 of the substrate 22 that is to be worked and the drilling head 14, there is sufficient space to attach the positioning apparatus 27 to the guide rail 23. The positioning apparatus 27 is placed onto the guide rail 23 and the magnet 41 affixes the positioning apparatus 27 on the guide rail 23. Subsequently, the laser unit 31 is switched on by means of the ON-OFF switch 38.

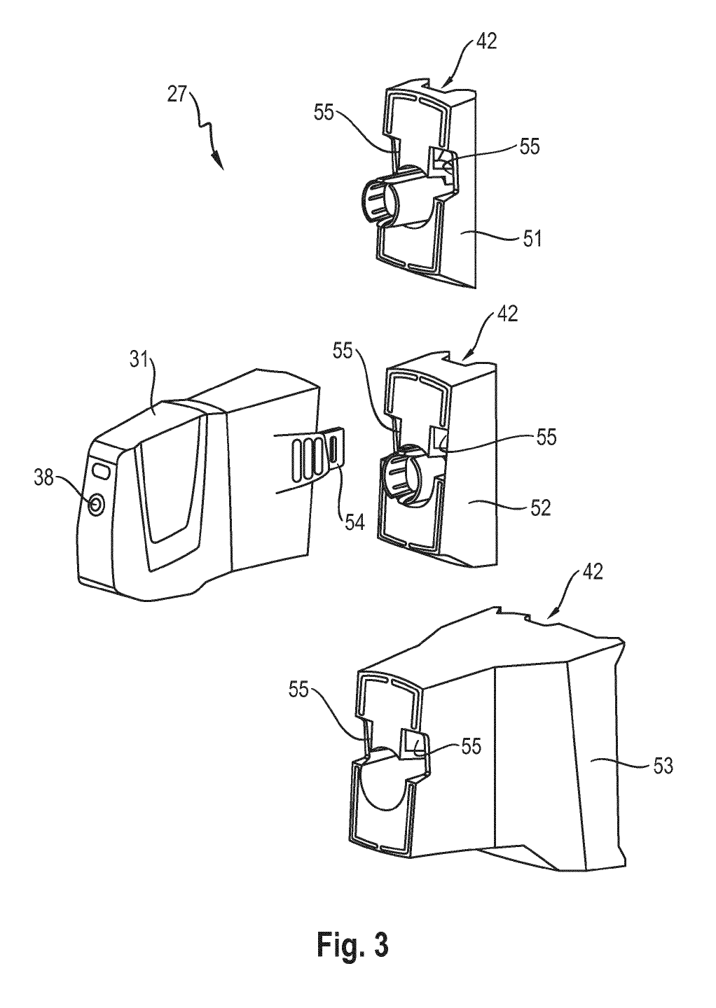

FIG. 3 shows the positioning apparatus 27 with the laser unit 31 and several adapter parts 51, 52, 53 that are adapted to different tool stands and/or different core drills, and that have different depths. Drill stands that are suited for core drills with large drilling heads 14 have a greater distance between the guide rail 23 and the drive shaft 15 than do drill stands that are only suited for core drills with smaller drilling heads 14. The different distances between the guide rail 23 and the drive shaft 15 are taken into account in that the adapter parts have different depths.

The laser unit 31 is connected to the adapter parts 51, 52, 53 via the adapter latch 33. On the housing 36 of the laser unit 31, there are two tabs 54 that are inserted into fitting grooves 55 in the adapter parts 51, 52, 53, where they latch.

1-5. (canceled)

6. A device system for drilling a hole having a center point in a substrate, said device system comprising:
a power tool with a drilling head attachable to a drive shaft and rotatable around an axis of rotation;
a tool stand with a guide rail and a guide block to hold the power tool;
a feed mechanism for moving the power tool along the guide rail; and
a positioner for determining the center point of the hole to be drilled, the positioner including an emitter to emit one or more laser beams, the positioner attachable to the guide rail by a fastener.

7. The device system as recited in claim 6 wherein the fastener has a magnet.

8. The device system as recited in claim 6 wherein the positioner has a guide on a side facing the guide rail.

9. The device as recited in claim 6 wherein the positioner includes a laser unit having the emitter as well as an adapter part having the fastener, the laser unit and the adapter part connectable via a connector.

10. The device system as recited in claim 9 wherein the adapter includes a first adapter part for a first power tool or for a first tool stand, and a second adapter part for a second power tool or for a second tool stand, the first and second power tools or the first and second tool stands differing in terms of the distance between the drive shaft and the guide rail.
